(19) United States
(12) Patent Application Publication
(10) Pub. No.: US 2007/0246579 A1
(43) Pub. Date: Oct. 25, 2007

(54) Blower assembly

(76) Inventor: Frank Blateri, Coppell, TX (US)

Correspondence Address: HAYNES AND BOONE, LLP, 901 MAIN STREET, SUITE 3100, DALLAS, TX, 75202, US

(21) Appl. No.: 11/391,100

(22) Filed: Mar. 28, 2006

(51) Int. Cl. B05B 1/00

(52) U.S. Cl. 239/599; 239/600; 239/597; 239/598; 15/344; 15/405

(57) ABSTRACT

A blower assembly according to which a nozzle is attached to a base unit. The nozzle receives compressed air from the base unit and discharges it.

### BACKGROUND

This invention relates to a blower assembly and a method of attaching a nozzle to a base unit of the blower assembly so that air is compressed by the base unit and the nozzle discharges the air.

### BRIEF DESCRIPTION OF THE DRAWINGS

FIG. 1 is an exploded, isometric view of a blower assembly according to an embodiment of the present invention.

FIG. 2 is a view similar to that of FIG. 1, but depicting the assembly in an assembled condition.

FIGS. 3 and 4 are enlarged, partial, isometric views of a latch mechanism in the embodiment of FIGS. 1 and 2.

### DETAILED DESCRIPTION

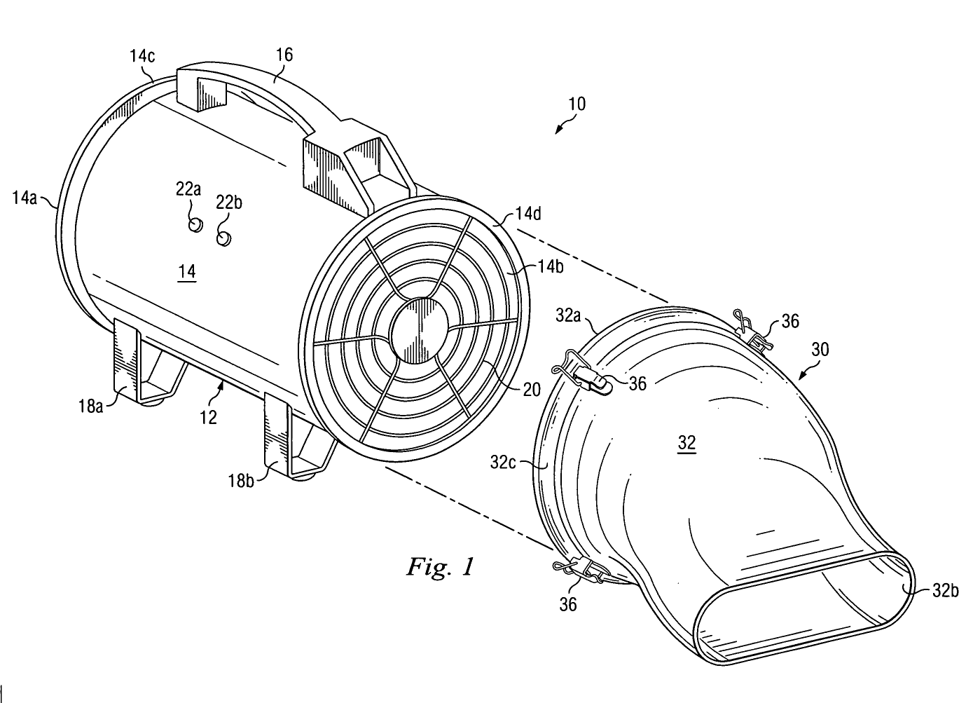

Referring to FIG. 1, the reference numeral 10 refers, in general, to a blower assembly according to an embodiment of the invention. The assembly 10 consists of a base unit 12 consisting of a cylindrical, hollow, body member 14 having an inlet end 14a and an outlet end 14b. A handle 16 is affixed to one outer surface thereof, and a pair of legs 18a and 18b are affixed to a diametrically opposite surface. A grill, or grate 20 is disposed at the outlet end 14b of the body member, and a similar grill, or grate (not shown) is disposed at the inlet end 14a. A pair of annular flanges 14c and 14d are provided at the respective ends 14a and 14b of the body member and project radially outwardly.

Although not shown in the drawings, it is understood that an air compression system is located in the interior of the body member 14, and can consist of a conventional blade assembly and a motor for rotating the blade assembly. As a result, air is drawn into the interior of the body member 14 through the inlet end 14a, is compressed in the interior of the body member as it passes through the above blade assembly, and is then discharged through the outlet end 14b and the grill 20. Two switch buttons 22a and 22b are provided on the exterior of the body member 14 for controlling operation of the motor, such as turning it on and off, and/or regulating its speed, also in a conventional manner.

A nozzle 30 is provided that consists of a hollow body member 32 having an inlet end 32a with a circular cross-section that corresponds to the cross-section of the end 14a of the body member 14. The body member 32 has an outlet end 32b with a substantially rectangular cross-section with rounded side walls as viewed in FIG. 1. The cross-sectional area of the outlet end 32b of the body member 32 is less than the cross sectional area of the inlet end 32a and therefore the outlet end 14b of the body member 14. Thus, the body member 32 changes in shape along its axial length as it transits from the end 32a to the end 32b. An annular flange 32c is provided at the inlet end 32a of the body member 32 and projects radially outwardly.

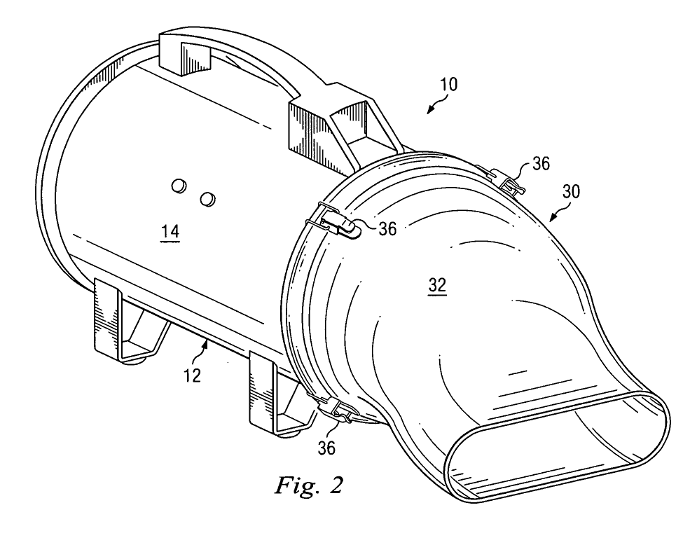

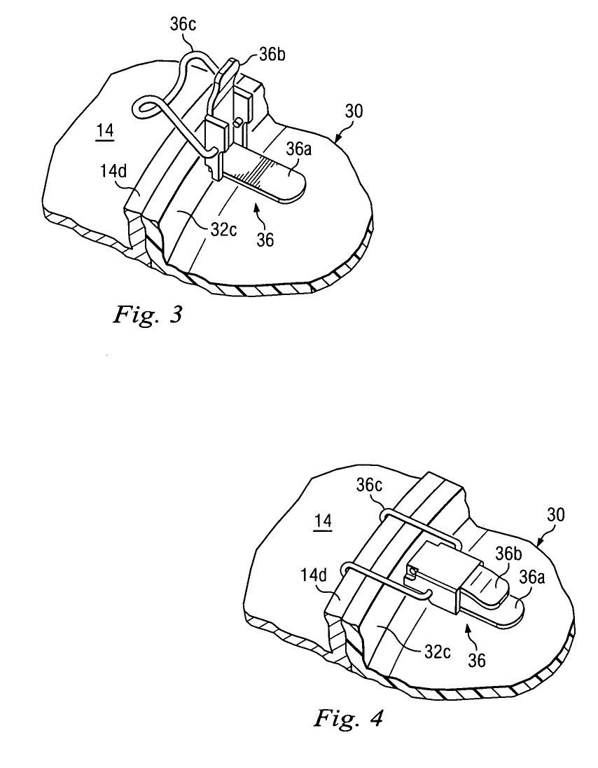

The body member 32 is attached to the body member 14 as shown in FIG. 2 by four angularly-spaced latching mechanisms 36, three of which are shown in FIGS. 1 and 2 and one of which is shown in detail in FIGS. 3 and 4.

Referring to FIG. 3, the latching mechanism 36 consists of a base member 36a that is fastened to the outer surface of the body member 32 adjacent the flange 32c in any conventional manner. An actuating arm 36b is pivotally mounted to the base member 36a, and a clasp 36c is attached to the arm 36b. With the actuating arm 36b in an up, or released, position, as shown in FIG. 3, the clasp 36c is moved away from the base member 36a, and when the arm is manually pivoted to its down position shown in FIG. 4, the clasp moves towards the base member.

To attach the body member 32 to the body member 14, the end 32a of the body member 32 is placed in abutment with the end 14b of the body member 14 with the flange 32c also abutting the flange 14d. The arm 36a is moved to its up, or released position so that the clasp 36c extends over the flanges 32c and 14d. The arm 36b is then manually pivoted to its down position shown in FIG. 4 causing the clasp 36c to move towards the body member 36a, engage the flange 14d, and thus press the flange 14d against the flange 32c with enough force to secure the nozzle 30 to the body member 14.

To release the nozzle 30 from the body member 14, the arm is moved to its up, or released position to disconnect the clasp from the flange 14d and permit the body member 32 to be removed from the body member 14.

It is understood that the other three latching mechanisms 36 operate in an identical manner.

Thus, the nozzle 30 can be attached to the body member 14 quickly and easily, thus permitting the velocity of the compressed air discharging from the end 14b of the body member 14 to be increased before it discharges from the end 32b of the nozzle. Also, the nozzle 30 can be quickly and easily removed from the base member 12 for the purposes of maintenance, cleaning, etc.

### Variations

Any type of motor, such as an electric or gasoline motor, can be used to compress the air in the body member 14.

The nozzle 30 is not limited to the specific shape shown in the drawings but can take other shapes.

Spatial references, such as “side”, “adjacent”, “angular”, etc. are for the purpose of illustration only and do not limit the specific orientation or location of the structure described above.

Those skilled in the art will readily appreciate that many other variations and modifications of the embodiment described above are possible without materially departing from the novel teachings and advantages of this invention. Accordingly, all such variations and modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A blower assembly comprising:
a base unit comprising an inlet for receiving air and an outlet for discharging the air;
means in the base unit for compressing the air before it discharges from the outlet;
a nozzle having an inlet and an outlet; and
at least one latching mechanism for attaching the nozzle to the base unit with the inlet of the nozzle in communication with the outlet of the base unit, so that the nozzle receives the compressed air from the outlet of the base unit;
the nozzle increasing the velocity of the air as it passes through the nozzle and discharges from the outlet of the nozzle.

2. The assembly of claim 1 wherein the latching mechanism comprises a base member fastened to the outer surface of the nozzle, an actuating arm pivotally mounted to the base member, and a clasp attached to the arm.

3. The assembly of claim 2 further comprising a flange formed on the outlet end portion of the base unit, and a flange formed on the inlet end portion of the nozzle and adapted to abut the flange on the outlet end portion of the base unit.

4. The assembly of claim 3 wherein the clasp extends over the flange of the base unit and wherein the arm is adapted to pivot to a position where it forces the clasp against the flange of the base unit, which forces the flange of the base unit against the flange of the nozzle to attach the nozzle to the base unit.

5. The assembly of claim 1 wherein the cross-sections of the outlet of the base unit and the inlet of the nozzle are circular and the cross-section of the outlet of the nozzle is substantially rectangular.

6. The assembly of claim 1 wherein the cross-sectional area of the outlet of the nozzle is less than the cross-sectional area of the outlet of the base unit.

7. A method of attaching a nozzle to a base unit that receives air, compresses the air and discharges the compressed air, the method comprising:
providing a first flange on the base unit and a second flange on the nozzle;
placing the flanges in abutment;
placing a portion of a latching mechanism over the first flange; and
actuating the latching mechanism to press the first flange towards the second flange with a force sufficient to attach the nozzle to the base unit;
the nozzle increasing the velocity of the air as it passes through the nozzle and discharges from the outlet of the nozzle.

8. The method of claim 7 wherein the step of actuating comprises pivoting an arm of the latching mechanism so that a clasp attached to the arm presses the first flange towards the second flange.
